(19) United States
(12) Patent Application Publication
(10) Pub. No.: US 2025/0051147 A1
(43) Pub. Date: Feb. 13, 2025

(54) Wire Rope Hoist With Swivel Sheave

(71) Applicant: Columbus McKinnon Corporation, Getzville, NY (US)

(72) Inventors: Jordan Benn, Charlotte, NC (US); Wesley Clark, Charlotte, NC (US)

(21) Appl. No.: 18/232,911

(22) Filed: Aug. 11, 2023

(51) Int. Cl. B66D 3/26; B66D 3/20

(52) U.S. Cl. CPC B66D 3/26; B66D 3/20

(57) ABSTRACT

A hoisting assembly for use with a wire rope. A rope guide is configured to mount around a rotating drum having a spiral rope groove defined therein. The spiral rope groove on the rotating drum is configured to receive the hoisting rope as it winds and unwinds from the rotating drum. The rope guide is configured to move laterally relative to the rotating drum to keep the hoisting rope in the spiral rope groove when winding the hoisting rope onto the rope groove or unwinding it from the rope groove. A sheave set may be configured to move along the longitudinal axis of the rotating drum while the hoist rope is unwinding from the rotating drum. The sheave set tensions and guides the hoisting rope and works in connection with a swivel sheave to accommodate the rope angle with respect to the axis of the rotating drum. Accordingly, the assembly is configured for spooling and unspooling the hoist rope to move the load in a completely vertical direction.

### TECHNICAL FIELD

The present invention relates generally to the field of material handling equipment such as hoists and cranes, and more particularly to a wire rope hoist with a sheave mounted on a swivel.

### BACKGROUND ART

A wire rope hoist is configured with a rotating drum having spiral grooves defined therein for receiving a hoisting rope. The spiral rope groove on the rotating drum is configured to receive the hoisting rope as it winds and unwinds from the rotating drum. A rope guide is configured to mount around the rotating drum. The rope guide is configured to move laterally relative to the rotating drum to keep the hoisting rope in the spiral rope groove when winding the hoisting rope onto the rope groove or unwinding it from the rope groove. A motor drives the rotating drum which spools or unspools the wire rope thereby raising or lowering a load. An issue with wire rope hoist is “hook drift” where the hook moves laterally when the load needs to be raised in only the vertical direction. What is needed is a device that spools and unspools in a completely vertical direction.

### BRIEF SUMMARY OF THE INVENTION

With parenthetical reference to the corresponding parts, portions or surfaces of the disclosed embodiment, merely for the purposes of illustration and not by way of limitation, the present invention meets the above described need by providing a wire rope hoist assembly (10) for raising and lowering a load. The wire rope hoist assembly (10) includes a rotating drum (39) having a spiral rope groove defined therein. The rotating drum (39) has a longitudinal axis.

A frame (15) supports the rotating drum (39). A shaft (29) is operatively associated with the rotating drum (39).

A motor (24) is configured to engage with and rotate the shaft (29).

A hoisting rope (12) is affixed to the drum (39) and is configured to wind into and unwind from the spiral rope groove.

A rope guide (11) is configured to mount around the rotating drum (39). The rope guide (11) is configured to move laterally relative to the rotating drum (39) to keep the hoisting rope in the spiral rope groove when winding the hoisting rope (12) into the rope groove or unwinding it from the rope groove.

At least one threaded shaft (78) is disposed substantially parallel to the longitudinal axis of the rotating drum (39). The at least one threaded shaft (78) is configured to rotate relative to the frame (15).

At least one first sheave (52) is mounted on a member (82) having a threaded opening configured to receive the threaded shaft (78). The member (82) is prevented from rotation such that rotation of the at least one threaded shaft (78) causes linear motion of the member (82) in a direction parallel to the longitudinal axis of the rotating drum (39).

A support structure (37) extends from the frame (15) in spaced apart relation to the rotating drum (39). A second sheave (42) is pivotally mounted on the support structure (37).

The wire rope hoist assembly (10) is configured such that the hoist rope (12) passes through the rope guide (11) and engages with the first sheave (52) and then engages with the second sheave (42).

A hook (26) for raising and lowering the load is connected to the hoist rope (12) and is disposed on a side of the second sheave (42) opposite from the rotating drum (39).

In another aspect of the invention, the at least one threaded shaft comprises a pair of threaded shafts (78, 81) disposed in spaced apart relation and parallel to the longitudinal axis of the rotating drum (39).

In another aspect, the at least one first sheave comprises a sheave set (51).

In yet another aspect, the sheave set (51) comprises a pair of sheaves (52, 53) connected to the members (82, 86).

In another aspect, the motor (24) is powered by a cordless power source.

In another aspect of the invention, the cordless power source is selected from the group consisting of lithium ion, lithium polymer, nickel-metal hydride, nickel cadmium, and lead-acid batteries.

Another aspect is that the cordless power source comprises an ultracapacitor.

In an additional embodiment of the invention, a wire rope hoist assembly (10) has a rotating drum (39) supported by a frame (15). The rotating drum (39) has a longitudinal axis and is driven by a shaft (29). The assembly (10) of the additional embodiment comprises a first threaded shaft (78) supported on the frame (15) and configured to rotate relative to the frame (15).

A second threaded shaft (81) is supported on the frame (15) and is configured to rotate relative to the frame (15).

A first pulley (60) is operatively associated with the shaft (39).

A second pulley (66) is driven by the first pulley (60) via a belt (63). The second pulley (66) is operatively associated with a first gear (69).

A second gear (72) is connected to the first threaded shaft (78) and is configured to engage with the first gear (69).

A third gear (75) is connected to the second threaded shaft (81) and is configured to engage with the first gear (69).

The first and second threaded shafts (78, 81) are mechanically coupled such that rotation of the shaft (29) on the rotating drum (39) causes the first threaded shaft (78) and the second threaded shaft (81) to rotate.

In another aspect, a first threaded nut (84) is disposed on the first threaded shaft (78).

In another aspect of the invention, a second threaded nut (87) is disposed the second threaded shaft (81).

In another aspect a sheave set (51) is connected to the first threaded nut (84) and second threaded nut (87) such that rotation of the first and second threaded shafts (78, 81) with the first and second threaded nuts (84, 87) prevented from rotating causes linear motion of the sheave set (51) along an axis parallel to the longitudinal axis of the rotating drum (39).

Another embodiment of the invention provides a wire rope hoist assembly (10) for raising and lowering a load. The wire rope hoist assembly (10) includes a rotating drum (39) having a spiral rope groove defined therein. The rotating drum (39) has a longitudinal axis.

A frame (15) supports the rotating drum (39).

A shaft (29) is operatively associated with the rotating drum (39).

A motor (24) is configured to engage with and rotate the shaft (29).

A hoisting rope (12) is affixed to the drum (39) and is configured to wind into and unwind from the spiral rope groove.

A rope guide (11) is configured to mount around the rotating drum (39). The rope guide (11) is configured to move laterally relative to the rotating drum (39) to keep the hoisting rope (12) in the spiral rope groove when winding the hoisting rope (12) into the rope groove or unwinding it from the rope groove.

A first threaded shaft (78) is supported on the frame (15) and is configured to rotate relative to the frame (15).

A second threaded shaft (81) is supported on the frame (15) and is configured to rotate relative to the frame (15).

A first pulley (60) is operatively associated with the shaft (39).

A second pulley (66) is driven by the first pulley (60) via a belt (63). The second pulley (66) is operatively associated with a first gear (69).

A second gear (72) is connected to the first threaded shaft (78) and is configured to engage with the first gear (69).

A third gear (75) is connected to the second threaded shaft (81) and is configured to engage with the first gear (69).

The first and second threaded shafts (78, 81) are mechanically coupled such that rotation of the shaft (29) on the rotating drum (39) causes the first threaded shaft (78) and the second threaded shaft (81) to rotate.

A first threaded nut (84) is disposed on the first threaded shaft (78).

A second threaded nut (87) is disposed on the second threaded shaft (81).

A sheave set (51) is connected to the first threaded nut (84) and the second threaded nut (87) such that rotation of the first and second threaded shafts (78, 81) with the first and second threaded nuts (84, 87) prevented from rotating causes linear motion of the sheave set (51) along an axis parallel to the longitudinal axis of the rotating drum (39).

A support structure (37) extends from the frame (15) in spaced apart relation to the rotating drum (39).

A swivel sheave (42) is pivotally mounted on the support structure (37).

The assembly (10) is configured such that the hoisting rope (12) passes through the rope guide (11) and engages with the sheave set (51) and then engages with the swivel sheave (42).

A hook for raising and lowering the load is connected to the hoist rope (12) and is disposed on a side of the swivel sheave (42) opposite from the rotating drum (39).

Accordingly, the assembly (10) is configured to spool and unspool the hoisting rope to raise and lower a load in a completely vertical direction.

### BRIEF DESCRIPTION OF THE DRAWINGS

FIG. 1 is a perspective view of one embodiment of a wire rope hoist assembly of the present invention.

FIG. 2 is another perspective view of the wire rope hoist assembly shown in FIG. 1.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

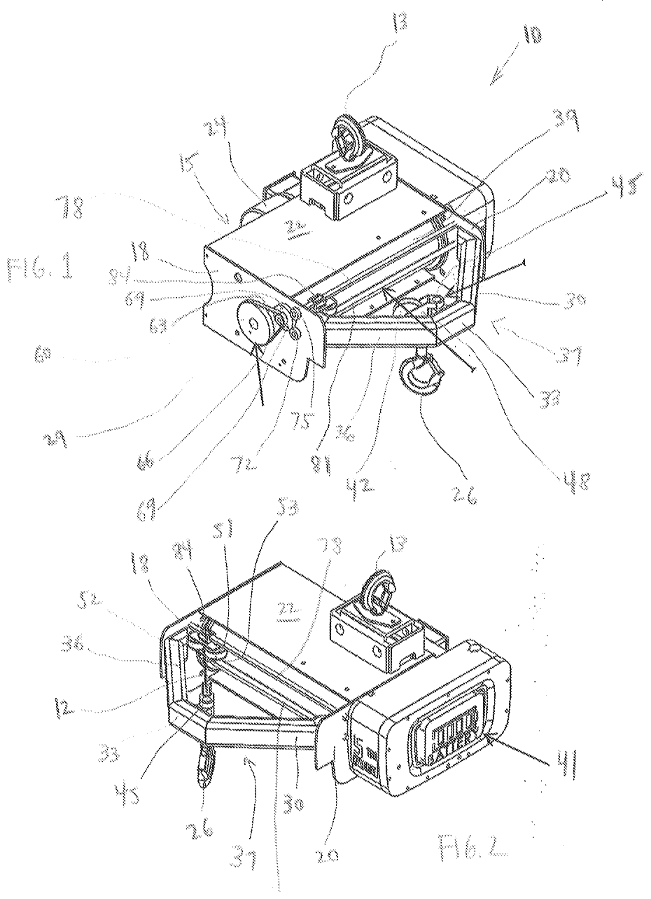

Referring now to FIGS. 1-2 generally, and initially to FIG. 1 thereof, this invention provides a hoist assembly 10 for use with a hoisting rope 12 (FIG. 2). The hoist assembly 10 may be supported from above by a hook 13. The hoist assembly 10 may be provided with a frame 15 having a pair of opposed side walls 18 and 20. A top cover 22 may also be provided. A motor 24 may rotate a shaft 29 connected to the drum 39 for winding and unwinding the rope 12 for raising and lowering a load from a hook 26. The motor 24 may receive power from a cordless power source such as a battery 41 (FIG. 2). The battery 41 may include, but is not limited to, a lithium ion, lithium polymer, nickel-metal hydride, nickel cadmium, or lead-acid batteries or ultracapacitors.

The hook 26 may be disposed in spaced apart relation to a front opening of the frame 15. A plurality of structural members 30, 33, and 36 may be combined to form a support structure 37 for the hook 26. The support structure 37 may extend from the front of the frame 15 in spaced apart relation to the drum 39. As shown, the structural members 30, 33, and 36 may comprise three sections of a support structure 37. Each section may be substantially straight, and the structural members 30, 33, 36 may be connected at angles. The structural members 30, 33, 36 may be constructed of steel or other suitable rigid materials and may be hollow to reduce weight. As will be evident to persons of ordinary skill in the art based on this disclosure, the structural members 30, 33, 36 may be replaced with a curved unitary structure or other combinations of straight or curved structural members to provide a support structure 37 for locating the hook 26 in spaced apart relation to the front of the drum 39.

A sheave 42 (best shown in FIG. 1) may be pivotally supported from the support structure 37 and the sheave 42 may be configured to rotate about a pivot point 45 which forms a vertical axis. The sheave 42 is oriented vertically and receives the hoisting rope 12 which is connected to the hook 26. The sheave 42 is rotatably mounted on a sheave structure 48. The sheave 42 may be mounted for rotation about a horizontal axis. The sheave structure 48 is pivotally supported on support structure 37 such that it rotates about a vertical axis. The sheave structure 48 may be mounted at approximately the same height as the payout from the drum 39, and the sheave structure 48 may be configured to pivot or swivel such that the sheave 42 aligns with the hoisting rope 12 as it exits from different angles from the drum 39.

The rotating drum 39 has a spiral shaped groove (not shown) defined therein. As will be evident to those of ordinary skill in the art based on this disclosure, a rope guide 11 (not shown) has an opening that receives the hoisting rope 12. The structure of the rope guide 11 surrounding the opening restricts the rope 12 from moving laterally and thereby keeps the hoisting rope 12 in position in the spiral groove on the rotating drum 39 as the rope 12 winds around the rotating drum 39 and unwinds from the rotating drum 39. The winding and unwinding of the rope 12 from the rotating drum 39 corresponds with the hoist 10 raising and lowering a load as will be described herein. The rope guide 11 travels laterally relative to the rotating drum 39 in accordance with the movement of the spiral groove from right to left and vice versa as the drum 39 rotates.

A sheave set 51 which may include a pair of sheaves 52, 53 mounted close together such that the rope 12 passes between the two sheaves 52, 53 may be included to provide tension for the hoisting rope 12 and to guide the hoisting rope 12 between the rope guide 11 on the drum 39 and the swivel sheave 42. The hook 26 is connected to the hoisting rope 12 on the side of the sheave 42 opposite from the drum 39.

The sheave set 51 may be configured to move in the axial direction in concert with the wire rope 12 exiting the drum 39. A first pulley 60 may connected to the shaft 29 which is operatively associated with the rotating drum 39. The first pulley 60 may be connected by a belt 63 to a second pulley 66 operatively associated with a first gear 69. The first gear 69 may engage with a pair of gears 72, 75 connected to threaded shafts 78, 81 extending from one side of the hoist frame 15 to the other side of the hoist frame 15 and configured to rotate freely relative to the hoist frame 15. Each of the gears 72, 75 driven by the pulleys 60, 66 rotates the threaded shafts 78, 81 along with the rotating drum 39. The sheave set 51 may be attached to a first threaded member such as a nut 84 on the first threaded shaft 78 and a second threaded member such as nut 87 (not shown) on the second threaded shaft 81. The first and second nuts 84, 87 are prevented from rotation, and therefore the rotation of the threaded shafts 78, 81 causes the sheave set 51 to move from left to right with respect to FIG. 1 along an axis parallel to the longitudinal axis of the drum 39.

The sheave 42 mounted on support structure 37 swivels to accommodate the rope angle with respect to the axis of the rotating drum 39.

The present invention contemplates that many changes and modifications may be made. Therefore, while the presently-preferred form of the wire rope hoist assembly has been shown and described, and several modifications and alternatives discussed, persons skilled in this art will readily appreciate that various additional changes and modifications may be made without departing from the spirit of the invention, as defined and differentiated by the following claims.

1. A wire rope hoist assembly for raising and lowering a load, the wire rope hoist system, comprising:
a rotating drum having a spiral rope groove defined therein, the rotating drum having a longitudinal axis;
a frame supporting the rotating drum;
a shaft operatively associated with the rotating drum;
a motor configured to engage with and rotate the shaft;
a hoisting rope affixed to the drum and configured to wind into and unwind from the spiral rope groove;
a rope guide configured to mount around the rotating drum, the rope guide configured to move laterally relative to the rotating drum to keep the hoisting rope in the spiral rope groove when winding the hoisting rope into the rope groove or unwinding it from the rope groove;
at least one threaded shaft disposed substantially parallel to the longitudinal axis of the rotating drum, the at least one threaded shaft configured to rotate relative to the frame;
at least one first sheave mounted on a member having a threaded opening configured to receive the threaded shaft, the member being prevented from rotation such that rotation of the at least one threaded shaft causes linear motion of the member in a direction parallel to the longitudinal axis of the rotating drum;
a support structure extending from the frame in spaced apart relation to the rotating drum;
a second sheave pivotally mounted on the support structure;
wherein the wire rope hoist assembly is configured such that the hoist rope passes through the rope guide and engages with the first sheave and then engages with the second sheave;
wherein a hook for raising and lowering the load is connected to the hoist rope and is disposed on a side of the second sheave opposite from the rotating drum.

2. The wire rope hoist assembly of claim 1, wherein the at least one threaded shaft comprises a pair of threaded shafts disposed in spaced apart relation and parallel to the longitudinal axis of the rotating drum.

3. The wire rope hoist assembly of claim 2, wherein the at least one first sheave comprises a sheave set.

4. The wire rope hoist assembly of claim 3, wherein the sheave set comprises a pair of sheaves connected to the member.

5. The wire rope hoist assembly of claim 1, wherein the motor is powered by a cordless power source.

6. The wire rope hoist assembly of claim 5, wherein the cordless power source is selected from the group consisting of lithium ion, lithium polymer, nickel-metal hydride, nickel cadmium, and lead-acid batteries.

7. The wire rope hoist assembly of claim 5, wherein the cordless power source comprises an ultracapacitor.

8. An assembly for a wire rope hoist having a rotating drum supported by a frame, the rotating drum having a longitudinal axis and being driven by a shaft, the assembly comprising:
a first threaded shaft supported on the frame and configured to rotate relative to the frame;
a second threaded shaft supported on the frame and configured to rotate relative to the frame;
a first pulley operatively associated with the shaft;
a second pulley driven by the first pulley via a belt, the second pulley operatively associated with a first gear;
a second gear connected to the first threaded shaft and configured to engage with the first gear;
a third gear connected to the second threaded shaft and configured to engage with the first gear;
wherein the first and second threaded shafts are mechanically coupled such that rotation of the shaft on the rotating drum causes the first threaded shaft and the second threaded shaft to rotate.

9. The assembly of claim 8, further comprising a first threaded nut disposed on the first threaded shaft.

10. The assembly of claim 9, further comprising a second threaded nut disposed the second threaded shaft.

11. The assembly of claim 10, further comprising a sheave set connected to the first threaded nut and second threaded nut such that rotation of the first and second threaded shafts with the first and second threaded nuts prevented from rotating causes linear motion of the sheave set along an axis parallel to the longitudinal axis of the rotating drum.

12. A wire rope hoist assembly for raising and lowering a load, the wire rope hoist system, comprising:
a rotating drum having a spiral rope groove defined therein, the rotating drum having a longitudinal axis;
a frame supporting the rotating drum;
a shaft operatively associated with the rotating drum;
a motor configured to engage with and rotate the shaft;
a hoisting rope affixed to the drum and configured to wind into and unwind from the spiral rope groove;
a rope guide configured to mount around the rotating drum, the rope guide configured to move laterally relative to the rotating drum to keep the hoisting rope in the spiral rope groove when winding the hoisting rope into the rope groove or unwinding it from the rope groove;
a first threaded shaft supported on the frame and configured to rotate relative to the frame;
a second threaded shaft supported on the frame and configured to rotate relative to the frame;
a first pulley operatively associated with the shaft;
a second pulley driven by the first pulley via a belt, the second pulley operatively associated with a first gear;
a second gear connected to the first threaded shaft and configured to engage with the first gear;
a third gear connected to the second threaded shaft and configured to engage with the first gear;
wherein the first and second threaded shafts are mechanically coupled such that rotation of the shaft on the rotating drum causes the first threaded shaft and the second threaded shaft to rotate,
a first threaded member disposed on the first threaded shaft,
a second threaded member disposed the second threaded shaft,
a sheave set connected to the first threaded member and second threaded member such that rotation of the first and second threaded shafts with the first and second threaded members prevented from rotating causes linear motion of the sheave set along an axis parallel to the longitudinal axis of the rotating drum;
a support structure extending from the frame in spaced apart relation to the rotating drum;
a swivel sheave pivotally mounted on the support structure;
wherein the assembly is configured such that the hoisting rope passes through the rope guide and engages with the sheave set and then engages with the swivel sheave;
wherein a hook for raising and lowering the load is connected to the hoist rope and is disposed on a side of the swivel sheave opposite from the rotating drum.
